(19) United States
(12) Patent Application Publication
(10) Pub. No.: US 2023/0298411 A1
(43) Pub. Date: Sep. 21, 2023

(54) ALARM TYPE DETERMINING APPARATUS

(71) Applicant: SUBARU CORPORATION, Tokyo (JP)

(72) Inventors: Yuta GOTO, Tokyo (JP); Chooi Chuan SIM, Tokyo (JP); Takuya KANETA, Tokyo (JP); Iyo HASHIMOTO, Tokyo (JP)

(21) Appl. No.: 18/176,043

(22) Filed: Feb. 28, 2023

(30) Foreign Application Priority Data
Mar. 15, 2022 (JP) 2022-040789

(51) Int. Cl. G07C 5/08; G07C 5/02; G07C 5/00; B60C 23/04

(52) U.S. Cl. CPC G07C 5/0816; B60C 23/0401; G07C 5/008; G07C 5/02

(57) ABSTRACT

An alarm type determining apparatus includes a state detector, an abnormality state determining unit, a traveling state determining unit, an alarm type determining unit, and a notifier. The state detector is configured to detect a state of a tire of a vehicle. The abnormality state determining unit is configured to determine an abnormality state of the tire, on the basis of the state of the tire detected by the state detector. The traveling state determining unit is configured to determine a traveling state of the vehicle. The alarm type determining unit is configured to determine an alarm type, on the basis of the abnormality state of the tire determined by the abnormality state determining unit and the traveling state of the vehicle determined by the traveling state determining unit. The notifier is configured to make a notification based on the alarm type determined by the alarm type determining unit.

### CROSS-REFERENCE TO RELATED APPLICATIONS

The present application claims priority from Japanese Patent Application No. 2022-040789 filed on Mar. 15, 2022, the entire contents of which are hereby incorporated by reference.

### BACKGROUND

The disclosure relates to an alarm type determining apparatus.

A vehicle emergency call device has been known in recent years that, to protect an occupant of a vehicle, makes an emergency call to an emergency call center in a case where a predetermined signal is received. Examples of the predetermined signal include a signal indicating that a device such as an airbag device or a seatbelt pretensioner is activated, and a signal supplied from a shock sensor such as an acceleration sensor mounted on the vehicle.

For example, Japanese Unexamined Patent Application Publication (JP-A) No. 2016-057693 discloses a technique related to the vehicle emergency call device that notifies the emergency call center of information that makes it possible to understand in more detail an emergency situation that has occurred on a vehicle upon making the emergency call to the emergency call center. Examples of the information include location information of the vehicle, the number of occupants in the vehicle acquired from various sensors, whether a seatbelt is worn, a contact direction, a presence of multiple vehicle contact, a presence of overturn, and a change in vehicle speed before and after a contact.

### SUMMARY

An aspect of the disclosure provides an alarm type determining apparatus for a vehicle. The alarm type determining apparatus includes a state detector, an abnormality state determining unit, a traveling state determining unit, an alarm type determining unit, and a notifier. The state detector is configured to detect a state of a tire of the vehicle. The abnormality state determining unit is configured to determine an abnormality state of the tire, on the basis of the state of the tire detected by the state detector. The traveling state determining unit is configured to determine a traveling state of the vehicle. The alarm type determining unit is configured to determine an alarm type, on the basis of the abnormality state of the tire determined by the abnormality state determining unit and the traveling state of the vehicle determined by the traveling state determining unit. The notifier is configured to make a notification that is based on the alarm type determined by the alarm type determining unit.

An aspect of the disclosure provides an alarm type determining apparatus for a vehicle. The alarm type determining apparatus includes a sensor and circuitry. The sensor is configured to detect a state of a tire of the vehicle. The circuitry is configured to: determine an abnormality state of the tire, on the basis of the state of the tire detected by the sensor; determine a traveling state of the vehicle; determine an alarm type, on the basis of the determined abnormality state of the tire and the determined traveling state of the vehicle; and make a notification that is based on the determined alarm type.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram schematically illustrating an example of an alarm type determining apparatus according to one example embodiment of the disclosure.

FIG. 2 is a flowchart illustrating a process flow to be executed by the alarm type determining apparatus illustrated in FIG. 1.

FIG. 3 is a flowchart illustrating a process flow to be executed by the alarm type determining apparatus illustrated in FIG. 1.

FIG. 4 is a diagram schematically illustrating an example of an alarm type determining apparatus according to one example embodiment of the disclosure.

FIG. 5 is a flowchart illustrating a process flow to be executed by the alarm type determining apparatus illustrated in FIG. 4.

FIG. 6 is a flowchart illustrating a process flow to be executed by the alarm type determining apparatus illustrated in FIG. 4.

FIG. 7 is a diagram schematically illustrating an example of an alarm type determining apparatus according to one example embodiment of the disclosure.

FIG. 8 is a flowchart illustrating a process flow to be executed by the alarm type determining apparatus illustrated in FIG. 7.

FIG. 9 is a flowchart illustrating a process flow to be executed by the alarm type determining apparatus illustrated in FIG. 7.

### DETAILED DESCRIPTION

A technique disclosed in JP-A No. 2016-057693 makes it difficult to notify an emergency call center of an emergency unless any occupant operates a button upon an occurrence of a contact accident of an own vehicle or in a case where the contact accident of the own vehicle is not occurred.

Accordingly, it has been difficult to call for appropriate rescue in a situation where an occurrence of a contact accident is easily predictable and where operating a button for notifying the emergency call center of the emergency is barely possible due to all of the occupants in the own vehicle being panicked, such as in a case where the own vehicle travels at a high speed and a tire burst is occurred.

It is desirable to provide an alarm type determining apparatus that makes it possible to call for appropriate rescue.

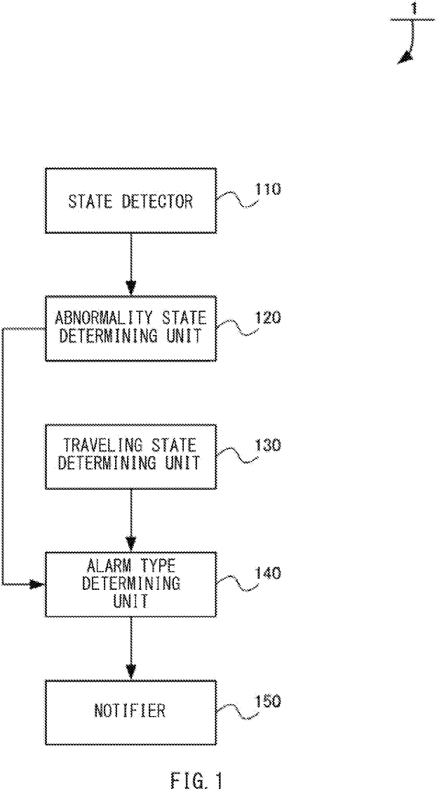

In the following, some example embodiments of the disclosure are described in detail with reference to FIGS. 1 to 9. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### First Example Embodiment

Described now with reference to FIGS. 1 to 3 is an alarm type determining apparatus 1 according to a first example embodiment.

### [Configuration of Alarm Type Determining Apparatus 1]

Referring to FIG. 1, the alarm type determining apparatus 1 according to the example embodiment includes a state detector 110, an abnormality state determining unit 120, a traveling state determining unit 130, an alarm type determining unit 140, and a notifier 150.

The state detector 110 detects a state of a tire of a vehicle. In one embodiment, the state detector 110 may serve as a “detector”.

Non-limiting examples of the wording “the state of the tire of the vehicle” may include whether the tire of the traveling vehicle is normal, punctured, or has burst.

In the example embodiment, the state detector 110 may be a pneumatic sensor that is attached inside the tire and measures a factor such as an internal pressure of the tire. The state detector 110 may transmit data related to a measured air pressure to the later-described abnormality state determining unit 120 by, for example, a wireless communication.

The abnormality state determining unit 120 may determine an abnormality state of the tire, on the basis of the data on the air pressure of the tire received from the state detector 110.

In some embodiments, the abnormality state determining unit 120 may determine that the state of the tire is a first abnormality state, in a case where the air pressure of the tire is decreased by a predetermined value or greater within a predetermined time. In some embodiments, the first abnormality state may be a state in which the tire has the burst.

In some embodiments, the abnormality state determining unit 120 may determine that the state of the tire is a second abnormality state, in a case where the air pressure of the tire is not decreased by the predetermined value or greater within the predetermined time. In some embodiments, the second abnormality state may be a state in which the tire is punctured.

In some embodiments, the abnormality state determining unit 120 may determine that the state of the tire is normal, in a case where the air pressure of the tire is hardly changed within the predetermined time.

The abnormality state determining unit 120 may output a result of the determination to the later-described alarm type determining unit 140.

The traveling state determining unit 130 determines a traveling state of the vehicle.

Non-limiting examples of the wording “the traveling state of the vehicle” may include a vehicle speed of the vehicle and a type of a traveling road on which the vehicle travels, such as a limited highway or a general road. The limited highway may refer to a road on which only a vehicle is allowed to travel.

The traveling state determining unit 130 may output a result of the determination to the later-described alarm type determining unit 140.

The alarm type determining unit 140 determines an alarm type, on the basis of the abnormality state of the tire determined by the abnormality state determining unit 120 and the traveling state of the vehicle determined by the traveling state determining unit 130.

In some embodiments, the alarm type determining unit 140 may determine that the alarm type is an “emergency call”, in a case where the tire has the burst and the vehicle speed of the vehicle is equal to or higher than a predetermined speed or the vehicle travels on the limited highway.

In some embodiments, the alarm type determining unit 140 may determine that the alarm type is a “request for a roadside assistance”, in a case where the tire has the burst and the vehicle speed of the vehicle is less than the predetermined speed.

In some embodiments, the alarm type determining unit 140 may determine that the alarm type is the “request for a roadside assistance” regardless of the vehicle speed of the vehicle, in a case where the tire has a major degree of puncture.

In some embodiments, the alarm type determining unit 140 may determine that the alarm type is a “warning within a passenger cabin” regardless of the vehicle speed of the vehicle, in a case where the tire has a minor degree of puncture.

The notifier 150 makes a notification that is based on the alarm type determined by the alarm type determining unit 140. For example, the notifier 150 may make a call to an external facility, make a request to an external facility, or perform a notification inside a passenger cabin, on the basis of a result of the determination by the alarm type determining unit 140. In some embodiments, the notifier 150 may make the notification by sending a sound, a voice, and/or information. In some embodiments, the notifier 150 may display an image of a content of the notification.

### [Process of Alarm Type Determining Apparatus 1]

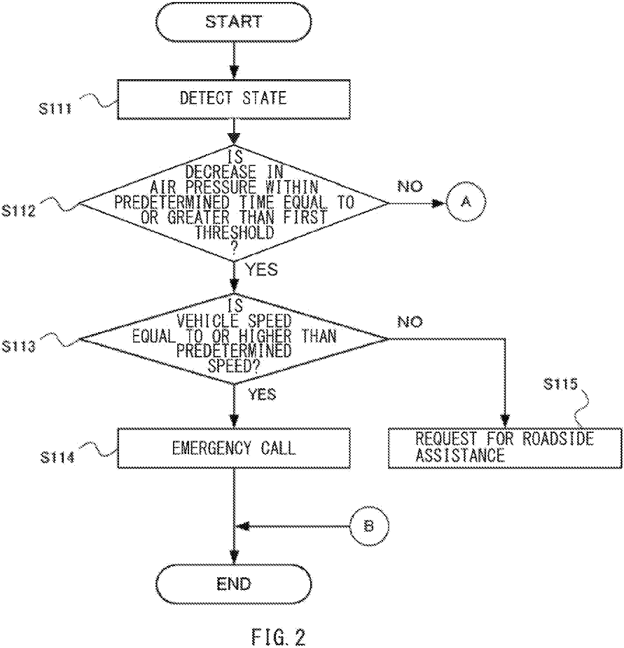

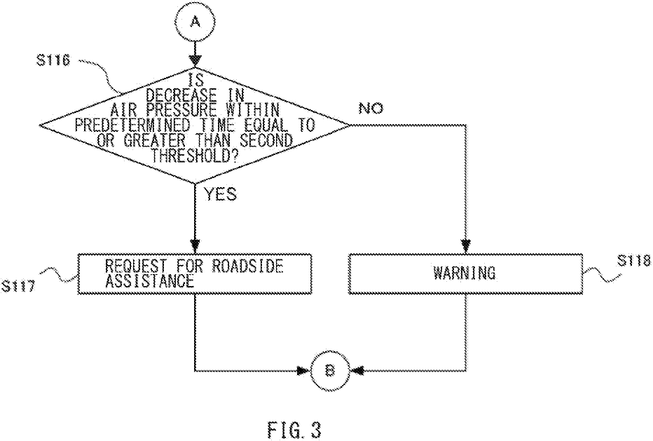

Described now with reference to FIGS. 2 and 3 is a process to be executed by the alarm type determining apparatus 1 according to the example embodiment.

Referring to FIG. 2, the state detector 110 may detect the air pressure of the tire as the state of the tire of the vehicle (step S111).

The abnormality state determining unit 120 may determine whether the decrease in the air pressure of the tire within the predetermined time is equal to or greater than a first threshold (step S112). If the abnormality state determining unit 120 determines that the decrease in the air pressure of the tire within the predetermined time is equal to or greater than the first threshold, e.g., if the abnormality state determining unit 120 determines that the tire has the burst (“YES” in step S112), the abnormality state determining unit 120 may determine whether the vehicle speed of the vehicle is equal to or higher than a predetermined speed, on the basis of a result of the determination by the traveling state determining unit 130 (step S113).

If the abnormality state determining unit 120 determines that the decrease in the air pressure of the tire within the predetermined time is equal to or greater than the first threshold, e.g., if the abnormality state determining unit 120 determines that the tire has the burst (“YES” in step S112) and that the vehicle speed of the vehicle is equal to or higher than the predetermined speed (“YES” in step S113), the abnormality state determining unit 120 may provide the alarm type determining unit 140 with a notification that the decrease in the air pressure of the tire within the predetermined time is equal to or greater than the first threshold and that the vehicle speed of the vehicle is equal to or higher than the predetermined speed.

In a case where the alarm type determining unit 140 receives the notification from the abnormality state determining unit 120, the alarm type determining unit 140 may determine that the alarm type is the emergency call (step S114), and provide the notifier 150 with a notification that the alarm type is the emergency call.

The notifier 150 may make the emergency call to an emergency call center.

If the abnormality state determining unit 120 determines that the decrease in the air pressure of the tire within the predetermined time is equal to or greater than the first threshold, e.g., if the abnormality state determining unit 120 determines that the tire has the burst (“YES” in step S112) and that the vehicle speed of the vehicle is less than the predetermined speed (“NO” in step S113), the abnormality state determining unit 120 may provide the alarm type determining unit 140 with a notification that the decrease in the air pressure of the tire within the predetermined time is equal to or greater than the first threshold and that the vehicle speed of the vehicle is less than the predetermined speed.

In a case where the alarm type determining unit 140 receives the notification from the abnormality state determining unit 120, the alarm type determining unit 140 may determine that the alarm type is the request for the roadside assistance (step S115), and provide the notifier 150 with a notification that the alarm type is the request for the roadside assistance.

The notifier 150 may make a call, to a roadside assistance provider, that requests a roadside assistance.

If the abnormality state determining unit 120 determines that the decrease in the air pressure of the tire within the predetermined time is less than the first threshold, e.g., if the abnormality state determining unit 120 determines that the tire has a medium degree or a minor degree of puncture (“NO” in step S112), the abnormality state determining unit 120 may determine whether the decrease in the air pressure of the tire within the predetermined time is equal to or greater than a second threshold (step S116).

If the abnormality state determining unit 120 determines that the decrease in the air pressure of the tire within the predetermined time is equal to or greater than the second threshold, e.g., if the abnormality state determining unit 120 determines that the tire has the medium degree of puncture or higher (“YES” in step S116), the abnormality state determining unit 120 may provide the alarm type determining unit 140 with a notification that the decrease in the air pressure of the tire within the predetermined time is equal to or greater than the second threshold.

In a case where the alarm type determining unit 140 receives the notification from the abnormality state determining unit 120, the alarm type determining unit 140 may determine that the alarm type is the request for the roadside assistance (step S117), and provide the notifier 150 with a notification that the alarm type is the request for the roadside assistance.

The notifier 150 may make a call, to the roadside assistance provider, that requests a roadside assistance.

If the abnormality state determining unit 120 determines that the decrease in the air pressure of the tire within the predetermined time is less than the second threshold, e.g., if the abnormality state determining unit 120 determines that the tire has the minor degree of puncture (“NO” in step S116), the abnormality state determining unit 120 may provide the alarm type determining unit 140 with a notification that the decrease in the air pressure of the tire within the predetermined time is less than the second threshold.

In a case where the alarm type determining unit 140 receives the notification from the abnormality state determining unit 120, the alarm type determining unit 140 may determine that the alarm type is the warning within the passenger cabin (step S118), and provide the notifier 150 with a notification that the alarm type is the warning within the passenger cabin.

The notifier 150 may notify an occupant inside the passenger cabin of a warning.

### [Workings and Example Effects]

The abnormality state determining unit 120 of the alarm type determining apparatus 1 according to the example embodiment may determine the abnormality state of the tire, on the basis of data acquired from the state detector 110 that detects the air pressure of the tire.

The abnormality state of the tire during traveling of the vehicle such as the burst or the puncture of the tire can serve as a factor that induces a contact accident.

Accordingly, setting the abnormality state of the tire by which the occurrence of the contact accident is easily predictable as a target of the determination helps to quickly make an appropriate call for rescue of the occupant.

In addition, the alarm type determining unit 140 of the alarm type determining apparatus 1 according to the example embodiment determines the alarm type, on the basis of the abnormality state of the tire determined by the abnormality state determining unit 120 and the traveling state of the vehicle determined by the traveling state determining unit 130.

The occurrence of the contact accident can be predictable even higher in a case where the tire involves the abnormality state and the vehicle travels at the high speed.

Accordingly, setting both the abnormality state of the tire and the vehicle speed of the vehicle as elements for making the determination of the predictability of the occurrence of the contact accident helps to quickly make an appropriate call for rescue of the occupant.

Further, the notifier 150 of the alarm type determining apparatus 1 according to the example embodiment makes a notification that is based on the alarm type determined by the alarm type determining unit 140.

Accordingly, it helps to provide an appropriate service that is based on a situation, by making a request for a rescue for a situation in which an emergency is significantly high, such as a case where the tire has the burst and the vehicle travels at the high speed, while by suppressing an excessive request for a rescue for a situation in which the emergency and a risk are relatively low.

In some embodiments, the abnormality state determining unit 120 of the alarm type determining apparatus 1 according to the example embodiment may determine that the state of the tire is the first abnormality state, in a case where the air pressure of the tire is decreased by the predetermined value or greater within the predetermined time, and may determine that the state of the tire is the second abnormality state, in a case where the air pressure of the tire is not decreased by the predetermined value or greater within the predetermined time.

For example, the abnormality state determining unit 120 may determine that the state of the tire is the first abnormality state, e.g., the tire has the burst, in a case where a level of the decrease of the air pressure of the tire within the predetermined time is equal or greater than the predetermined value, and may determine that the state of the tire is the second abnormality state, e.g., the tire is punctured, in a case where the level of the decrease is less than the predetermined value.

Accordingly, it helps to appropriately determine the abnormality state of the tire by which the occurrence of the contact accident is easily predictable.

In some embodiments, the alarm type determining unit 140 of the alarm type determining apparatus 1 according to the example embodiment may determine that the alarm type is the emergency call, in a case where: the traveling state determining unit 130 determines, as the traveling state of the vehicle, that the vehicle speed of the vehicle is equal to or higher than the predetermined vehicle speed or determines that the vehicle travels on the limited highway; and the abnormality state determining unit 120 determines that the state of the tire is the first abnormality state.

For example, the alarm type determining unit 140 may determine that the alarm type is the emergency call, in a case where: the vehicle speed of the vehicle is determined as being equal to or higher than the predetermined vehicle speed or the vehicle is determined as traveling on the limited highway; and the state of the tire is determined as being the first abnormality state, e.g., the tire is determined as having the burst.

Accordingly, it helps to provide an appropriate service that is based on a situation, by making a request for a rescue for a situation in which an emergency is significantly high, such as a case where the tire has the burst and the vehicle travels at the high speed, while by suppressing an excessive request for a rescue for a situation in which the emergency and a risk are relatively low.

### [First Modification Example]

In the first example embodiment, the alarm type to be determined by the alarm type determining unit 140 may be classified into three types including the emergency call, the request for the roadside assistance, and the warning. In some embodiments, in a case where a state of the tire can possibly make the transition from the state in which the tire is punctured to the state in which the tire has the burst, the request for the roadside assistance may be made and a notification may be provided as the warning inside the passenger cabin that the tire can eventually have the burst at the time when the tire is still in the punctured state.

This helps to allow the occupant to recognize a situation predictable in the near future and to promote the occupant to take proper measures during the tire being still in the punctured state.

### [Second Modification Example]

In the first example embodiment, an appropriate service such as the emergency call, the request for the roadside assistance, or the warning may be provided on the basis of the state of the vehicle. In some embodiments where the vehicle has a driving assistance function, an appropriate drive assist may be executed on the basis of a level of emergency while monitoring a behavior of the vehicle.

This helps to prevent an accident before it happens.

### Second Example Embodiment

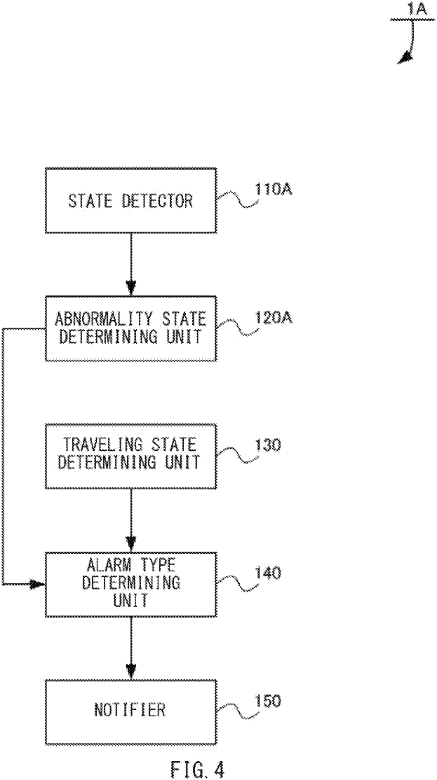

Described now with reference to FIGS. 4 to 6 is an alarm type determining apparatus 1A according to a second example embodiment.

### [Configuration of Alarm Type Determining Apparatus 1A]

Referring to FIG. 4, the alarm type determining apparatus 1A according to the example embodiment includes a state detector 110A, an abnormality state determining unit 120A, the traveling state determining unit 130, the alarm type determining unit 140, and the notifier 150.

It should be noted that elements denoted with the same reference numerals as the first example embodiment may have their respective functions similar to those described above and will not be described in detail accordingly.

The state detector 110A detects, as a state of the tire of the vehicle, a load applied to the vehicle.

Non-limiting examples of the wording “the state of the tire of the vehicle” may include whether the tire of the traveling vehicle is normal, punctured, or has the burst.

In the example embodiment, the state detector 110A may be a load sensor attached to a member to which the load of the vehicle is applied, for example. In an alternative example, the state detector 110A may be a pressure sensor provided on a top of a four-wheel suspension coil spring. The state detector 110A may transmit data related to a measured load or a measured pressure to the later-described abnormality state determining unit 120A by, for example, a wireless communication.

The abnormality state determining unit 120A may determine the abnormality state of the tire, on the basis of the data on the load or the pressure received from the state detector 110A.

In some embodiments, the abnormality state determining unit 120A may determine that the state of the tire is the first abnormality state, in a case where the load or the pressure is decreased by a predetermined value or greater within a predetermined time. In some embodiments, the first abnormality state may be a state in which the tire has the burst.

In some embodiments, the abnormality state determining unit 120A may determine that the state of the tire is the second abnormality state, in a case where the load or the pressure is not decreased by the predetermined value or greater within the predetermined time. In some embodiments, the second abnormality state may be a state in which the tire is punctured.

In some embodiments, the abnormality state determining unit 120A may determine that the state of the tire is normal, in a case where the load or the pressure is hardly changed within the predetermined time.

The abnormality state determining unit 120A may output a result of the determination to the alarm type determining unit 140.

### [Process of Alarm Type Determining Apparatus 1A]

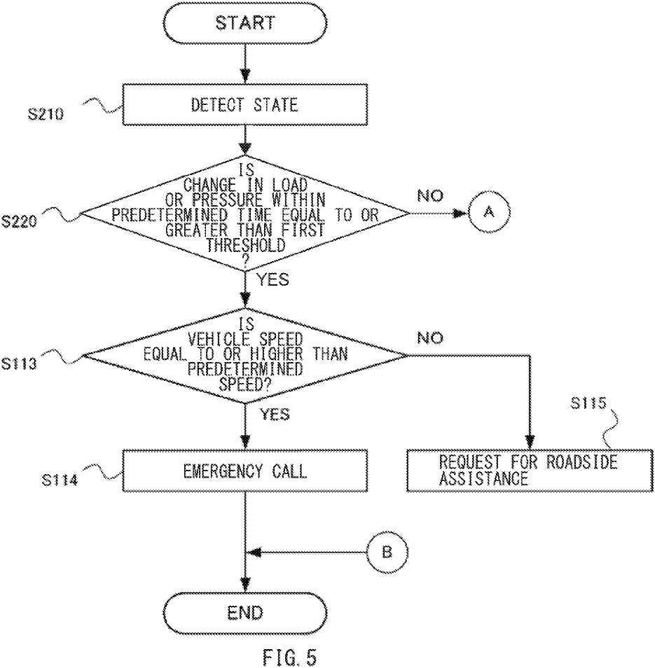

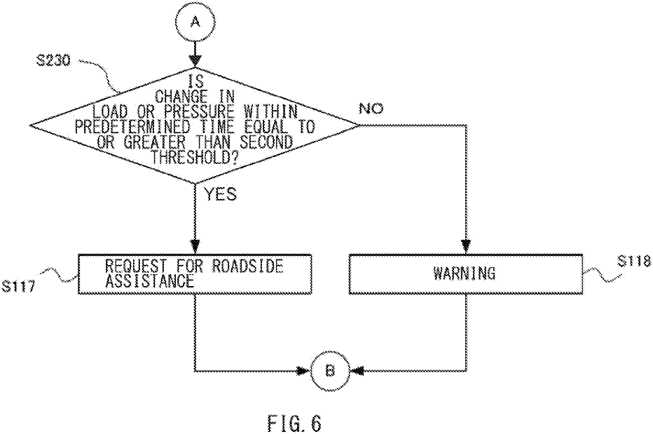

Described now with reference to FIGS. 5 and 6 is a process to be executed by the alarm type determining apparatus 1A according to the example embodiment.

Referring to FIG. 5, the state detector 110A may detect the load applied to the vehicle as the state of the tire of the vehicle (step S210).

The abnormality state determining unit 120A may determine whether the decrease in the load or the pressure within the predetermined time is equal to or greater than a first threshold (step S220). If the abnormality state determining unit 120A determines that the decrease in the load or the pressure within the predetermined time is equal to or greater than the first threshold, e.g., if the abnormality state determining unit 120A determines that the tire has the burst (“YES” in step S220), the abnormality state determining unit 120A may determine whether the vehicle speed of the vehicle is equal to or higher than the predetermined speed, on the basis of the result of the determination by the traveling state determining unit 130 (step S113).

If the abnormality state determining unit 120A determines that the decrease in the load or the pressure within the predetermined time is equal to or greater than the first threshold, e.g., if the abnormality state determining unit 120A determines that the tire has the burst (“YES” in step S220) and that the vehicle speed of the vehicle is equal to or higher than the predetermined speed (“YES” in step S113), the abnormality state determining unit 120A may provide the alarm type determining unit 140 with a notification that the decrease in the load or the pressure within the predetermined time is equal to or greater than the first threshold and that the vehicle speed of the vehicle is equal to or higher than the predetermined speed.

In a case where the alarm type determining unit 140 receives the notification from the abnormality state determining unit 120A, the alarm type determining unit 140 may determine that the alarm type is the emergency call (step S114), and provide the notifier 150 with the notification that the alarm type is the emergency call.

The notifier 150 may make the emergency call to the emergency call center.

If the abnormality state determining unit 120A determines that the decrease in the load or the pressure within the predetermined time is equal to or greater than the first threshold, e.g., if the abnormality state determining unit 120A determines that the tire has the burst (“YES” in step S220) and that the vehicle speed of the vehicle is less than the predetermined speed (“NO” in step S113), the abnormality state determining unit 120A may provide the alarm type determining unit 140 with a notification that the decrease in the load or the pressure within the predetermined time is equal to or greater than the first threshold and that the vehicle speed of the vehicle is less than the predetermined speed.

In a case where the alarm type determining unit 140 receives the notification from the abnormality state determining unit 120A, the alarm type determining unit 140 may determine that the alarm type is the request for the roadside assistance (step S115), and provide the notifier 150 with the notification that the alarm type is the request for the roadside assistance.

The notifier 150 may make a call, to the roadside assistance provider, that requests the roadside assistance.

If the abnormality state determining unit 120A determines that the decrease in the load or the pressure within the predetermined time is less than the first threshold (“NO” in step S220), the abnormality state determining unit 120A may determine whether the decrease in the load or the pressure within the predetermined time is equal to or greater than a second threshold (step S230).

If the abnormality state determining unit 120A determines that the decrease in the load or the pressure within the predetermined time is equal to or greater than the second threshold, e.g., if the abnormality state determining unit 120A determines that the tire has the medium degree of puncture or higher (“YES” in step S230), the abnormality state determining unit 120A may provide the alarm type determining unit 140 with a notification that the decrease in the load or the pressure within the predetermined time is equal to or greater than the second threshold.

In a case where the alarm type determining unit 140 receives the notification from the abnormality state determining unit 120A, the alarm type determining unit 140 may determine that the alarm type is the request for the roadside assistance (step S117), and provide the notifier 150 with the notification that the alarm type is the request for the roadside assistance.

The notifier 150 may make a call, to the roadside assistance provider, that requests the roadside assistance.

If the abnormality state determining unit 120A determines that the decrease in the load or the pressure within the predetermined time is less than the second threshold, e.g., if the abnormality state determining unit 120A determines that the tire has the minor degree of puncture (“NO” in step S230), the abnormality state determining unit 120A may provide the alarm type determining unit 140 with a notification that the decrease in the load or the pressure within the predetermined time is less than the second threshold.

In a case where the alarm type determining unit 140 receives the notification from the abnormality state determining unit 120A, the alarm type determining unit 140 may determine that the alarm type is the warning within the passenger cabin (step S118), and provide the notifier 150 with the notification that the alarm type is the warning within the passenger cabin.

The notifier 150 may notify the occupant inside the passenger cabin of a warning.

### [Workings and Example Effects]

The abnormality state determining unit 120A of the alarm type determining apparatus 1A according to the example embodiment may determine that the state of the tire is the first abnormality state, in a case where the load applied to the vehicle is decreased by the predetermined value or greater within the predetermined time, and may determine that the state of the tire is the second abnormality state, in a case where the load applied to the vehicle is not decreased by the predetermined value or greater within the predetermined time.

For example, the abnormality state determining unit 120A may determine that the state of the tire is the first abnormality state, e.g., the tire has the burst, in a case where a level of the decrease of the load applied to the vehicle within the predetermined time is equal or greater than the predetermined value, and may determine that the state of the tire is the second abnormality state, e.g., the tire is punctured, in a case where the level of the decrease is less than the predetermined value.

Accordingly, it helps to appropriately determine the abnormality state of the tire by which the occurrence of the contact accident is easily predictable.

### Third Example Embodiment

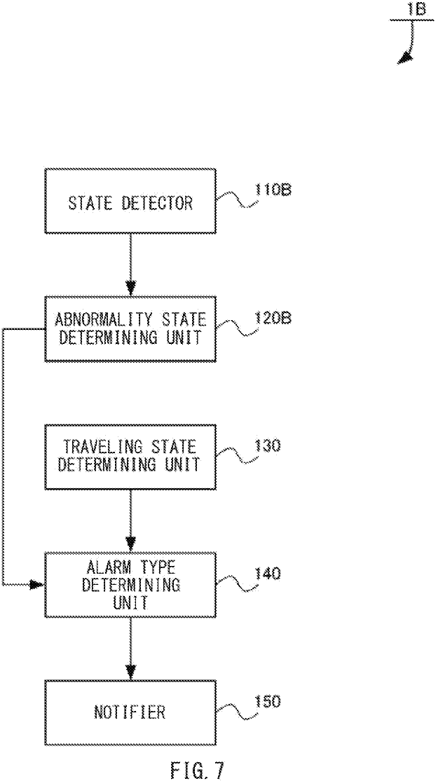

Described now with reference to FIGS. 7 to 9 is an alarm type determining apparatus 1B according to a third example embodiment.

### [Configuration of Alarm Type Determining Apparatus 1B]

Referring to FIG. 7, the alarm type determining apparatus 1B according to the example embodiment includes a state detector 110B, an abnormality state determining unit 120B, the traveling state determining unit 130, the alarm type determining unit 140, and the notifier 150.

It should be noted that elements denoted with the same reference numerals as the first and the second example embodiments may have their respective functions similar to those described above and will not be described in detail accordingly.

The state detector 110B detects, as a state of the tire of the vehicle, an inclination of the vehicle.

Non-limiting examples of the wording “the state of the tire of the vehicle” may include whether the tire of the traveling vehicle is normal, punctured, or has the burst.

In the example embodiment, the state detector 110B may be a gyroscope sensor that detects an angular velocity of the vehicle, for example. In an alternative example, the state detector 110B may be an acceleration sensor that detects an acceleration rate of a body of the vehicle. The state detector 110B may transmit data on an output of the sensor to the later-described abnormality state determining unit 120B by, for example, a wireless communication.

The abnormality state determining unit 120B may determine the abnormality state of the tire, on the basis of the sensor data received from the state detector 110B.

In some embodiments, the abnormality state determining unit 120B may determine that the state of the tire is the first abnormality state, in a case where the inclination of the vehicle is increased by a predetermined value or greater within a predetermined time. In some embodiments, the first abnormality state may be a state in which the tire has the burst.

In some embodiments, the abnormality state determining unit 120B may determine that the state of the tire is the second abnormality state, in a case where the inclination of the vehicle is not increased by the predetermined value or greater within the predetermined time. In some embodiments, the second abnormality state may be a state in which the tire is punctured.

In some embodiments, the abnormality state determining unit 120B may determine that the state of the tire is normal, in a case where the inclination of the vehicle is hardly changed within the predetermined time.

The abnormality state determining unit 120B may output a result of the determination to the alarm type determining unit 140.

### [Process of Alarm Type Determining Apparatus 1B]

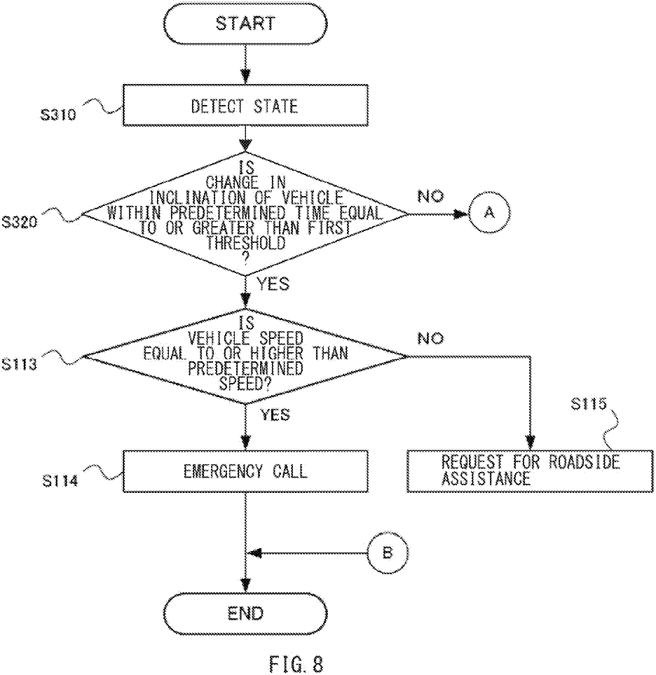

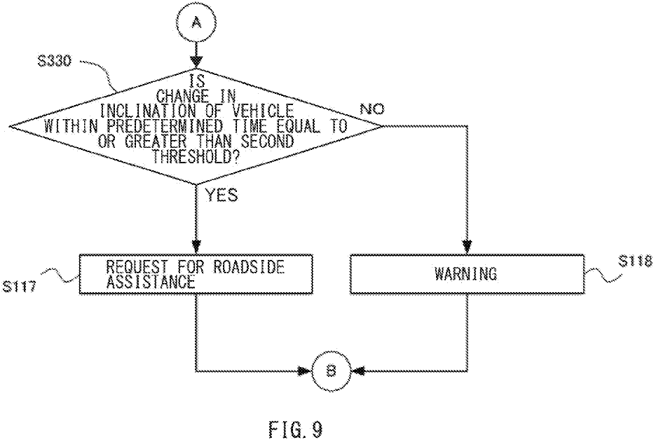

Described now with reference to FIGS. 8 and 9 is a process to be executed by the alarm type determining apparatus 1B according to the example embodiment.

Referring to FIG. 8, the state detector 110B may detect the inclination of the vehicle as the state of the tire of the vehicle (step S310).

The abnormality state determining unit 120B may determine whether the increase in the inclination of the vehicle within the predetermined time is equal to or greater than a first threshold (step S320). If the abnormality state determining unit 120B determines that the increase in the inclination of the vehicle within the predetermined time is equal to or greater than the first threshold, e.g., if the abnormality state determining unit 120B determines that the tire has the burst (“YES” in step S320), the abnormality state determining unit 120B may determine whether the vehicle speed of the vehicle is equal to or higher than the predetermined speed, on the basis of the result of the determination by the traveling state determining unit 130 (step S113).

If the abnormality state determining unit 120B determines that the increase in the inclination of the vehicle within the predetermined time is equal to or greater than the first threshold, e.g., if the abnormality state determining unit 120B determines that the tire has the burst (“YES” in step S320) and that the vehicle speed of the vehicle is equal to or higher than the predetermined speed (“YES” in step S113), the abnormality state determining unit 120B may provide the alarm type determining unit 140 with a notification that the increase in the inclination of the vehicle within the predetermined time is equal to or greater than the first threshold and that the vehicle speed of the vehicle is equal to or higher than the predetermined speed.

In a case where the alarm type determining unit 140 receives the notification from the abnormality state determining unit 120B, the alarm type determining unit 140 may determine that the alarm type is the emergency call (step S114), and provide the notifier 150 with the notification that the alarm type is the emergency call.

The notifier 150 may make the emergency call to the emergency call center.

If the abnormality state determining unit 120B determines that the increase in the inclination of the vehicle within the predetermined time is equal to or greater than the first threshold, e.g., if the abnormality state determining unit 120B determines that the tire has the burst (“YES” in step S320) and that the vehicle speed of the vehicle is less than the predetermined speed (“NO” in step S113), the abnormality state determining unit 120B may provide the alarm type determining unit 140 with a notification that the increase in the inclination of the vehicle within the predetermined time is equal to or greater than the first threshold and that the vehicle speed of the vehicle is less than the predetermined speed.

In a case where the alarm type determining unit 140 receives the notification from the abnormality state determining unit 120B, the alarm type determining unit 140 may determine that the alarm type is the request for the roadside assistance (step S115), and provide the notifier 150 with the notification that the alarm type is the request for the roadside assistance.

The notifier 150 may make a call, to the roadside assistance provider, that requests the roadside assistance.

If the abnormality state determining unit 120B determines that the increase in the inclination of the vehicle within the predetermined time is less than the first threshold (“NO” in step S320), the abnormality state determining unit 120B may determine whether the increase in the inclination of the vehicle within the predetermined time is equal to or greater than a second threshold (step S330).

If the abnormality state determining unit 120B determines that the increase in the inclination of the vehicle within the predetermined time is equal to or greater than the second threshold, e.g., if the abnormality state determining unit 120B determines that the tire has the medium degree of puncture or higher (“YES” in step S330), the abnormality state determining unit 120B may provide the alarm type determining unit 140 with a notification that the increase in the inclination of the vehicle within the predetermined time is equal to or greater than the second threshold.

In a case where the alarm type determining unit 140 receives the notification from the abnormality state determining unit 120B, the alarm type determining unit 140 may determine that the alarm type is the request for the roadside assistance (step S117), and provide the notifier 150 with the notification that the alarm type is the request for the roadside assistance.

The notifier 150 may make a call, to the roadside assistance provider, that requests the roadside assistance.

If the abnormality state determining unit 120B determines that the increase in the inclination of the vehicle within the predetermined time is less than the second threshold, e.g., if the abnormality state determining unit 120B determines that the tire has the minor degree of puncture (“NO” in step S330), the abnormality state determining unit 120B may provide the alarm type determining unit 140 with a notification that the increase in the inclination of the vehicle within the predetermined time is less than the second threshold.

In a case where the alarm type determining unit 140 receives the notification from the abnormality state determining unit 120B, the alarm type determining unit 140 may determine that the alarm type is the warning within the passenger cabin (step S118), and provide the notifier 150 with the notification that the alarm type is the warning within the passenger cabin.

The notifier 150 may notify the occupant inside the passenger cabin of a warning.

### [Workings and Example Effects]

The abnormality state determining unit 120B of the alarm type determining apparatus 1B according to the example embodiment may determine that the state of the tire is the first abnormality state, in a case where the inclination of the vehicle is increased by the predetermined value or greater within the predetermined time, and may determine that the state of the tire is the second abnormality state, in a case where the inclination of the vehicle is not increased by the predetermined value or greater within the predetermined time.

For example, the abnormality state determining unit 120B may determine that the state of the tire is the first abnormality state, e.g., the tire has the burst, in a case where a level of the increase of the inclination of the vehicle within the predetermined time is equal or greater than the predetermined value, and may determine that the state of the tire is the second abnormality state, e.g., the tire is punctured, in a case where the level of the increase is less than the predetermined value.

Accordingly, it helps to appropriately determine the abnormality state of the tire by which the occurrence of the contact accident is easily predictable.

In some embodiments, the alarm type determining apparatus 1, 1A, or 1B may be implemented by recording the process to be executed by the abnormality state determining unit 120, 120A, or 120B on a non-transitory computer-readable recording medium, and causing the computer system to load the program recorded on the recording medium onto the abnormality state determining unit 120, 120A, or 120B to execute the program. The computer system may encompass a hardware including, for example, an operating system (OS) and a peripheral device.

In some embodiments where the compute system utilizes a world wide web (WWW) system, the “computer system” may encompass a website providing environment or a website displaying environment. The program may be transmitted from a computer system that contains the program in a storage device or the like to another computer system via a transmission medium or by a carrier wave in a transmission medium. The “transmission medium” configured to transmit the program may refer to a medium having a function of transmitting data, including, for example, a network or a communication network such as the Internet and a communication link or a communication line such as a telephone line.

The program may be directed to implement a part of the function described above. The program may be a so-called differential file or a so-called differential program configured to implement the function by a combination of a program already recorded on the computer system.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

According to at least one embodiment of the disclosure, it is possible to provide an alarm type determining apparatus that makes it possible to call for appropriate rescue even in a situation where an occurrence of a contact accident is easily predictable and where operating a button by an occupant in a vehicle is barely possible.

As used herein, the term “collision” may be used interchangeably with the term “contact”. The abnormality state determining unit 120, 120A, and 120B respectively illustrated in FIGS. 1, 4, and 7 are each implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of any of the abnormality state determining unit 120, 120A, and 120B. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of any of the abnormality state determining unit 120, 120A, and 120B respectively illustrated in FIGS. 1, 4, and 7.

1. An alarm type determining apparatus for a vehicle, the alarm type determining apparatus comprising:
a state detector configured to detect a state of a tire of the vehicle;
an abnormality state determining unit configured to determine an abnormality state of the tire, on a basis of the state of the tire detected by the state detector;
a traveling state determining unit configured to determine a traveling state of the vehicle;
an alarm type determining unit configured to determine an alarm type, on a basis of the abnormality state of the tire determined by the abnormality state determining unit and the traveling state of the vehicle determined by the traveling state determining unit; and
a notifier configured to make a notification that is based on the alarm type determined by the alarm type determining unit.

2. The alarm type determining apparatus according to claim 1, wherein
the state detector is configured to detect, as the state of the tire, an air pressure of the tire, and
the abnormality state determining unit is configured to
determine that the state of the tire is a first abnormality state, in a case where the air pressure of the tire is decreased by a predetermined value or greater within a predetermined time, and
determine that the state of the tire is a second abnormality state, in a case where the air pressure of the tire is not decreased by the predetermined value or greater within the predetermined time.

3. The alarm type determining apparatus according to claim 1, wherein
the state detector is configured to detect, as the state of the tire, a load applied to the vehicle, and
the abnormality state determining unit is configured to
determine that the state of the tire is a first abnormality state, in a case where the load applied to the vehicle is decreased by a predetermined value or greater within a predetermined time, and
determine that the state of the tire is a second abnormality state, in a case where the load applied to the vehicle is not decreased by the predetermined value or greater within the predetermined time.

4. The alarm type determining apparatus according to claim 1, wherein
the state detector is configured to detect, as the state of the tire, an inclination of the vehicle, and
the abnormality state determining unit is configured to
determine that the state of the tire is a first abnormality state, in a case where the inclination of the vehicle is increased by a predetermined value or greater within a predetermined time, and
determine that the state of the tire is a second abnormality state, in a case where the inclination of the vehicle is not increased by the predetermined value or greater within the predetermined time.

5. The alarm type determining apparatus according to claim 2, wherein the alarm type determining unit is configured to determine that the alarm type is an emergency call, in a case where: the traveling state determining unit determines, as the traveling state of the vehicle, that a vehicle speed of the vehicle is equal to or higher than a predetermined vehicle speed or that the vehicle travels on a limited highway; and the abnormality state determining unit determines that the state of the tire is the first abnormality state.

6. The alarm type determining apparatus according to claim 3, wherein the alarm type determining unit is configured to determine that the alarm type is an emergency call, in a case where: the traveling state determining unit determines, as the traveling state of the vehicle, that a vehicle speed of the vehicle is equal to or higher than a predetermined vehicle speed or that the vehicle travels on a limited highway; and the abnormality state determining unit determines that the state of the tire is the first abnormality state.

7. The alarm type determining apparatus according to claim 4, wherein the alarm type determining unit is configured to determine that the alarm type is an emergency call, in a case where: the traveling state determining unit determines, as the traveling state of the vehicle, that a vehicle speed of the vehicle is equal to or higher than a predetermined vehicle speed or that the vehicle travels on a limited highway; and the abnormality state determining unit determines that the state of the tire is the first abnormality state.

8. An alarm type determining apparatus for a vehicle, the alarm type determining apparatus comprising:
a sensor configured to detect a state of a tire of the vehicle; and
circuitry configured to:
determine an abnormality state of the tire, on a basis of the state of the tire detected by the sensor;
determine a traveling state of the vehicle;
determine an alarm type, on a basis of the determined abnormality state of the tire and the determined traveling state of the vehicle; and
make a notification that is based on the determined alarm type.
